(19) United States
(12) Patent Application Publication
(10) Pub. No.: US 2022/0144000 A1
(43) Pub. Date: May 12, 2022

(54) METHOD AND DEVICE FOR THE LASER MARKING OF PLASTIC LABELS

(71) Applicant: PHOENIX CONTACT GmbH & Co. KG, Blomberg (DE)

(72) Inventors: Sandra Klocke, Vlotho (DE); Kilian Klages, Detmold (DE); Albrecht Schierholz, Schieder-Schwalenberg (DE)

(21) Appl. No.: 17/432,439

(22) PCT Filed: Feb. 19, 2020
(86) PCT No.: PCT/EP2020/054314

§ 371 Date: Aug. 19, 2021

(30) Foreign Application Priority Data
Feb. 22, 2019 (DE) 10 2019 202 435.1

(51) Int. Cl. B41M 5/26; B41J 3/407; B41J 2/475

(52) U.S. Cl. CPC B41M 5/267; B41J 2/4753; B41J 3/4075

(57) ABSTRACT

A method for laser marking plastics labels includes providing at least one plastics label to be marked. A marking laser that is a diode laser having at least one laser diode and no other laser-active medium is provided. The plastics label is marked by laser marking with the marking laser.

The present invention relates to a method and a device for the laser marking of plastics labels.

Terminal blocks for electrical installations, such as those installed in switch cabinets, for example, are often marked or labeled by means of plastics labels. The labels can be labeling profiles that are form-fittingly clamped into a receptacle provided on the terminal block. Such labels are, for example, marked or printed in specially provided labeling devices.

Known labeling devices often have high operating costs for the end user which arise, for example, due to high energy consumption, e.g. during laser marking, or the consumption of manufacturer-specific toner or ink cartridges and print media.

The present invention is based on the technical problem of specifying a method and a device for the laser marking of plastics labels which allow inexpensive, efficient laser marking of labels.

The technical problem described above is solved by a method according to claim 1 and a device according to claim 9. Other embodiments can be found in the dependent claims and the following description.

According to a first aspect, the invention relates to a method for the laser marking of plastics labels, comprising the method steps of: providing at least one plastics label to be marked; providing a marking laser, the marking laser being a diode laser comprising at least one laser diode and the marking laser having no other laser-active medium, such as an active fiber or the like; marking the plastics label by laser marking with the marking laser.

In the present case, the use of a diode laser offers the advantage of allowing inexpensive and efficient laser marking of plastics labels. The marking takes place in particular in that the plastics material of the plastics label is discolored due to the energy input by the laser.

When reference is made to a plastics label in the present case, this may be, for example, a multilayer material with an adhesive layer, such as a label sheet, a label roll or the like.

According to an embodiment of the invention, the plastics label is in particular a marker which can be formed, for example, from a solid material in an injection molding process and has shaped elements for fastening to terminals of electrical installations. A plurality of such markers can, for example, be provided in one piece as a card or mat, from which individual markers or several markers in combination can be removed.

The markers can, for example, have a surface to be inscribed, with protruding shaped elements such as ridges, latching hooks or the like being provided on a side of the marker facing away from the surface to be labeled. The shaped elements are designed in particular to engage form-fittingly in grooves or undercuts, for example of terminal blocks, in order to achieve a form-fitting and/or force-fitting connection between the terminal and the associated marker. In other words, such a marker can be locked to a terminal by means of a click or clamp connection.

A beam deflection for guiding the beam of the marking laser can be carried out by a galvano scanner or by providing axle drives for moving the beam source or optical system and/or the label.

Two or more plastics labels to be marked can be provided and marked, the plastics labels being provided in an ordered, standardized structural composite, such as a label roll, a label sheet, a label tree, a label card or the like. In this way, a plurality of labels can be marked successively in an efficient manner.

The labels initially provided in a structural composite should be separated automatically after marking. For example, individual labels can be detached from the structural composite so that they can be mounted separately from the other labels held on the structural composite.

If, for example, a label card is provided which accommodates a plurality of labels in a grid-like manner in rows and columns, individual row parts or column parts can be detached from the structural composite of the label card and mounted. For example, a plurality of labels arranged in a row can be jointly mounted on a terminal block, these having been separated from a label card. This allows efficient marking and mounting.

A label card can comprise labels that have shaped elements and/or clamping elements for form-fitting and/or force-fitting attachment to a conductor or a cable or a hose. A label can therefore have, for example, a clip, a hook, an eyelet or the like in order to be fastened form-fittingly and/or force-fittingly to a conductor or a cable or a hose.

In particular, each individual label can have such a shaped and/or clamping element as an integral component.

According to an embodiment of the method, the plastics labels can accordingly be arranged in rows and/or columns in the structural composite. The individual labels can be connected to one another by predetermined breaking points or separation points, along which the individual labels can be separated from one another in a simple manner, either manually or automatically.

According to a further embodiment of the method, the plastics label comprises one of the plastics materials polyamide, polycarbonate, polycarbonate-acrylonitrile-butadiene-styrene, polyethylene terephthalate, polyethylene, polyvinyl chloride or polyefin, or the plastics label consists of one of the plastics materials polyamide, polycarbonate, polycarbonate-acrylonitrile-butadiene-styrene, polyethylene terephthalate, polyethylene, polyvinyl chloride or polyefin. In principle, any plastics material that can be discolored by the energy input with the diode laser in order to produce a label can be used as the material for the plastics label.

The wavelength of the marking laser can be in a range of from 375 nm to 2000 nm, it being possible in particular that the wavelength of the marking laser is between 375 nm and 690 nm, more particularly between 690 nm and 2000 nm. The specified edge regions should be viewed as belonging to the regions.

The marking laser can be an edge emitter or a surface emitter. The power of the marking laser can be 0.01 watts-100 watts. Efficient marking of plastics labels can thus be achieved.

In order to allow simple and inexpensive provision of a plastics label, according to a further embodiment of the method the plastics label and a surface of the plastics label to be labeled can consist of the same plastics material that is marked directly by the marking laser. Accordingly, the label can be formed in one piece from a solid material. The surface to be labeled in particular has no carrier film, coating or the like, but is discolored directly by the energy input of the marking laser.

The plastics label can be a marker that has been formed from a solid material in an injection molding process and has shaped elements and/or clamping elements for fastening to terminals of electrical installations.

The plastics label can be a marker that has been formed from a solid material in an injection molding process and has shaped elements and/or clamping elements for fastening to conductors, cables or tubes of electrical installations.

A plastics label under discussion here can, for example, have a surface to be labeled having a width of 5 mm or less and a height of 11 mm or less.

According to a second aspect, the invention relates to a device for the laser marking of plastics labels, comprising a means for providing a plastics label to be marked, such as a support, an infeed or the like, comprising a marking laser, the marking laser being a diode laser having at least one laser diode and the marking laser having no other laser-active medium, such as an active fiber or the like.

The device is designed in particular to carry out the method described above.

The device allows efficient and inexpensive marking of plastics labels.

In order to allow mobile and flexible use of the device, a further embodiment of the device is characterized by a battery, the marking laser being battery-operated. It goes without saying that the device as a whole can be battery-operated. The battery can in particular be a permanently installed or replaceable accumulator. It goes without saying that the device can be designed as an alternative or in addition to network operation.

The device for laser marking can be a mobile device that has a weight of 10 kg or less, in particular a weight of 5 kg or less, more particularly a weight of 2 kg or less. The device can alternatively or additionally be a mobile device, the length, width and height of which are each less than 1 m.

The device can have a separating device which is set up to separate standardized plastics labels which are provided in an ordered manner in a structural composite from the structural composite.

For example, the separating device can be designed to detach one or more plastics labels, which are held, for example, in rows and columns on a sheet of labels or a label card, from the structural composite in order to form a separate unit that can be mounted on a terminal block, for example.

As a result, in particular individual labels and/or label strips can be provided in an automated and inexpensive manner, which labels and/or strips can then be automatically or manually mounted, for example, on a terminal block or other components of an electrical installation.

The invention is described in greater detail in the following with reference to drawings showing embodiments, in which, schematically:

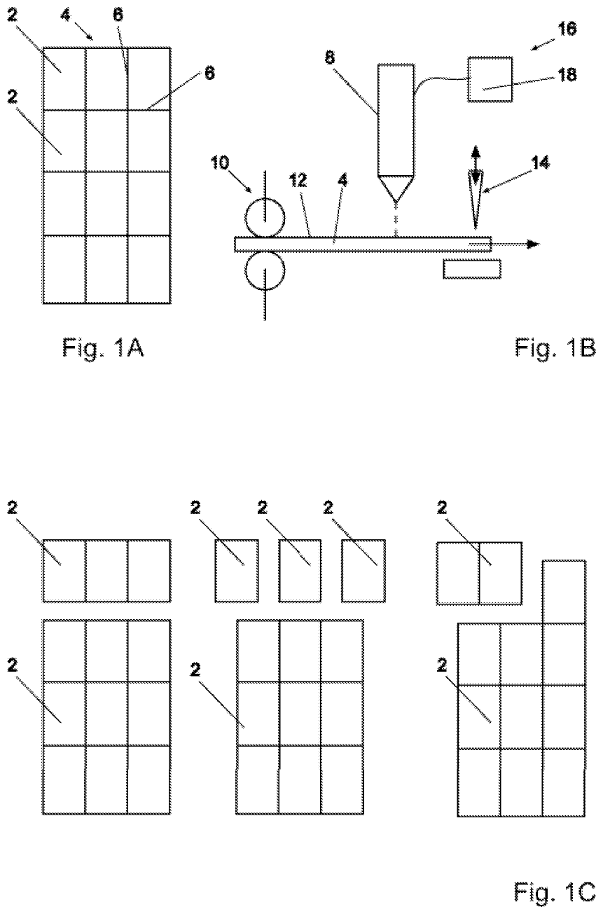

FIG. 1A shows the provision of a plastics label to be marked;

FIG. 1B shows the provision of a marking laser and the marking of the plastics label from FIG. 1A;

FIG. 1C shows the separation of the plastics label.

First, a plastics label 2 to be marked is provided. In the present case, a plurality of plastics labels 2 to be marked are provided, which are provided as a label card 4 in an ordered, standardized structural composite. Predetermined breaking points are formed along horizontal and vertical dividing lines 6 of the label card 4 in order to simplify the separation of the labels 2 after labeling.

As can be seen from FIG. 1B, a marking laser 8 is provided in order to label the label card 4. In the present case, the marking laser 8 is a diode laser which comprises a laser diode and which has no other laser-active medium, such as an active fiber or the like.

The label card 4 is guided past the marking laser 8 in the infeed movement indicated by the directional arrow by means of an infeed 10 and is labeled or marked. In the present case, the label card 4 consists of a single plastics material, of which the surface 12 of each of the plastics labels 2 to be labeled is also made. The marking or labeling takes place in that the plastics material of the plastics labels 2 is discolored due to the energy input of the marking laser 8.

After the marking, the labels 2 are separated automatically by means of a separating device 14.

The device 16 for laser marking shown in FIG. 1B, which device comprises the marking laser 8, the infeed 10 and the separating device 14, is a battery-operated device 16 which is supplied with energy by means of the battery 18, which is also integrated.

FIG. 1C shows three exemplary variants which illustrate a separation of the card 4 into individual labels 2 along the horizontal and vertical predetermined breaking lines 6.

### REFERENCE SIGNS

2 Plastics label
4 Label card
6 Dividing lines
8 Marking laser
10 Infeed
12 Surface
14 Separating device
16 Device for laser marking
18 Battery

1. A method for laser marking plastics labels, the method comprising steps of:
providing at least one plastics label to be marked;
providing a marking laser, wherein the marking laser is a diode laser having at least one laser diode, and wherein the marking laser has no further laser-active medium; and
marking the plastics label by laser marking with the marking laser.

2. The method according to claim 1, wherein:
two or more plastics labels to be marked are provided and marked, and
the plastics labels are provided in an ordered, standardized structural composite including one of a label roll, a label sheet, a label tree, or a label card.

3. The method according to claim 2, wherein the labels are separated automatically after marking.

4. The method according to either claim 2, wherein the plastics labels are arranged in rows and/or columns in the structural composite.

5. The method according to claim 1, wherein the plastics label comprises one of: polyamide, polycarbonate, polycarbonate-acrylonitrile-butadiene-styrene, polyethylene terephthalate, polyethylene, polyvinyl chloride, or polyefin, or
wherein the plastics label consists of one of: polyamide, polycarbonate, polycarbonate-acrylonitrile-butadiene-styrene, polyethylene terephthalate, polyethylene, polyvinyl chloride or polyefin.

6. The method according to claim 1, wherein:
a wavelength of the marking laser is 375 nm to 2000 nm, and/or
the marking laser is an edge emitter or the marking laser is a surface emitter.

7. The method according to claim 1, wherein:
the plastics label and a surface of the plastics label to be marked consist of a same plastics material that is marked directly by the marking laser, the surface to be marked not having a carrier film or coating, and/or
the plastics label is a marker formed from a solid material in an injection molding process and has shaped elements and/or clamping elements for fastening to terminals of electrical installations, and/or
the plastics label is a marker formed from a solid material in an injection molding process and has shaped elements and/or clamping elements for fastening to conductors, cables, or tubes of electrical installations.

8. The method according to wherein the plastics label has a surface to be marked having a width of 5 mm or less and a height of 11 mm or less.

9. A device for laser marking plastics labels, the device for providing a plastics label to be marked, the device comprising:
one of a support or an infeed; and
a marking laser,
wherein the marking laser is a diode laser comprising at least one laser diode, and
wherein the marking laser has no further laser-active medium.

10. The device for laser marking according to claim 9, further comprising a battery, the marking laser being battery-operated.

11. The device for laser marking, further comprising a separating device for separating standardized labels which are provided in an ordered manner in a structural composite.
